(19) United States
(12) Patent Application Publication
(10) Pub. No.: US 2014/0269724 A1
(43) Pub. Date: Sep. 18, 2014

(54) METHOD AND DEVICES FOR FORWARDING IP DATA PACKETS IN AN ACCESS NETWORK

(71) Applicant: Telefonaktiebolaget L M Ericsson (PUBL), Stockholm (SE)

(72) Inventors: Klaus Mehler, Geilenkirchen (DE); Dirk Kampmann, Vaals (NL); Michael Geisen, Herzogenrath (DE); Francisco Cortes Gomez, Wurselen (DE); Torbjoern Forsgren, Wurselen (DE)

(73) Assignee: Telefonaktiebolaget L M Ericsson (PUBL), Stockholm (SE)

(21) Appl. No.: 14/195,054

(22) Filed: Mar. 3, 2014

Related U.S. Application Data
(60) Provisional application No. 61/772,074, filed on Mar. 4, 2013.

(51) Int. Cl. H04L 12/725; H04L 12/741

(52) U.S. Cl. CPC H04L 45/30; H04L 45/74
USPC 370/392; 370/401

(57) ABSTRACT

A method of controlling forwarding of IP data packets through a service network. An IP data packet including an original source port number enters the network through a gateway node. A controller defines a path allocated to a service type through a forwarding node and a service-providing server allocated to the network; allocates an identifier to the service type; provides path-related forwarding rules to the forwarding node based on the identifier; and provides to the gateway node, the service-type identifier and a mapping rule between the identifier and the service type. The gateway node receives the IP data packet and determines which service type the IP data packet refers to; replaces the original source port number with a source port number encoding the identifier of the determined service type based on the mapping rule; and provides the IP data packet to the forwarding node for forwarding on the path.

### CROSS-REFERENCE TO RELATED APPLICATIONS

This application claims the priority benefit under 35 U.S.C. §119(e) of U.S. Provisional Application No. 61/772,074 filed on Mar. 4, 2013, the disclosure of which is incorporated herein by reference in its entirety.

### TECHNICAL FIELD

The present disclosure relates generally to communication systems and more particularly to a method of forwarding IP data packets through a service network.

### BACKGROUND

Access networks such as 2G/3G, LTE and fixed line access networks are connected to a gateway. Depending on the access type, the gateway node can be e.g. a Border Network Gateway (BNG), a Gateway GPRS Support Node (GGSN) or a Packet Gateway (PGW). At data session activation, the gateway provides end-users with an IP address; it handles authentication, accounting and charging and it may perform additional tasks like acting as Policy and Charging Enforcement Function (PCEF) in 3GPP networks. The gateway is the entry point to the Service Network which refers to an operator controlled network with one or multiple entities attached providing services that add value to the operator or to the end-user.

FIG. 1 is a simplified block diagram of an existing implementation of a Service Network. As shown in FIG. 1, the operator's demarcation towards the Internet is a Point of Interconnect (PoI). Since the IP address allocated to the end-user is typically a private IP address, Network Address Translation (NAT) to a public IP address is usually performed close to the PoI.

Service networks often include a number of Transparent Value Added Services (TVAS) which transparently process traffic traversing them. In the logical network architecture as shown in FIG. 1, TVAS are connected and belong logically to the Service Network. The term “transparent” is used in this case to refer to traffic processing functions which are not explicitly addressed by the traffic itself in any way and that are under the sole control of the telecommunications provider. This is as opposed to functions like Domain Name Server (DNS)-steered Content Delivery Network (CDN) servers, configurable proxies or services implemented by an IP Multimedia Subsystem (IMS) and explicitly addressed via Session Initiating Protocol (SIP). The main reason for the distinction of TVAS versus non-transparent VAS is that the transport network plays a central role in the usage of TVAS as it is the only entity able to direct traffic to one TVAS or not. The communication endpoints can, by definition of “transparent”, not steer the usage of a TVAS. In the same way, most existing TVAS do not implement any awareness of other potential TVAS or chaining among them and can therefore not steer traffic to another TVAS.

It shall be noted that the terms “value added service” is to be given a very broad interpretation including real and potential added value which may be value for the end-user, value for the network provider, or potentially for other parties. Examples of TVAS could be Firewalls, Spam filters, Antivirus services, Content Filtering, Parental Control, Transparent Internet Caches, HTTP Header enrichment or Deep Packet Inspection.

The need for TVAS to be deployed in legacy networks has resulted in strong dependencies between the service implementation itself and the transport network, with current TVAS products often being based on networking appliance platforms or making use of such. One example of these dependencies is that on high throughput routing/switching platforms all traffic need to be traversed through TVAS despite of only a fraction of it being really processed. One further example is the need for high-availability comparable to transport equipment even though the service itself does not require such high-availability. It shall be ensured that traffic sent via a TVAS is not dropped due to a TVAS failure. A further example of the dependency between the service implementation and the transport network is the need to implement integrated Network Address Translation (NAT)/Network Address and Port Translation (NAPT) functionality to steer return traffic back to the same function. Strong integration with load balancing functions in cases where stateful TVAS functions require smart load balancing to the right instance results in TVAS product including both load balancers as component, or creating limitations like maximum number of instances or strict connectivity requirement between load balancers and TVAS servers.

An extension of the traffic chain separation as described in FIG. 1 is to separate different traffic types in the gateway node. The L3 access network comprises different TVASs (TVAS-1, TVAS-2, TVAS-x) which are part of different Virtual Private Networks (VPNs). In this example VPN 1 comprises TVAS-1 and TVAS-2, wherein VPN 2 comprises TVAS-x.

FIG. 2 is a simplified block diagram of another existing implementation of a Service Network. For traffic entering the gateway node from an access network an Access Point Name (APN) is dynamically classified according to policy rules and then mapped to different sub-APNs, so called Service APNs. Each Service APN connects to one VPN as shown. One service chain per VPN can be defined. FIG. 2 shows a gateway node GGSN/PGW which is arranged between the Access network and a Layer 3 Network. The gateway node comprises a traffic classification entity for classifying traffic entering the gateway node from the access network according to a policy rule. Based on the classification an APN is allocated to the traffic. In this example three different APNs are available. There might be other examples with more or less APNs available. This depends on the granularity of the policy rules. One APN in this example is a base APN which is a kind of default APN for traffic which is not allocated to the other available APNs 1 and 2. Each of the three APNs is allocated to a VPN. To assure that packets are routed on the same VPN in downlink direction (from the PDN/Internet to the Access network), NAT needs to be applied at either end of the service network. As a consequence more than one IP address must be reserved and allocated to the end-user per active session. For each separated traffic-type one additional IP address must be allocated per end-user. In today's networks a huge amount of IP addresses have to be reserved. Apart from this one end-user has a different source IP address in the network behind the PoI depending on the number of TVAS chains he is using. Therefore a server in the PDN/Internet cannot identify an end-user by a unique IP address. Further in this scenario the TVASs cannot be shared between several APNs unless they support handling of different VPNs.

FIG. 3 is a simplified block diagram of an existing implementation of a Software Defined Network (SDN) implemented as a Service Network. SDN is an enabler to link in many TVAS only in data chains where they are really needed. Trusted traffic between an end-user and a server within the operator's network for example does not need to pass a firewall; and only video traffic needs to be processed by a video optimizer. Subscriber specific services (e.g. virus scanning, parental control) can be bound only for the specific subscribers. FIG. 3 depicts a SDN based traffic steering. The idea is to control the TVAS chain by a central controller. As shown in FIG. 3, all TVASs, the gateway and the PoI are connected to a SDN which can be, for example, according to the “OpenFlow” standard.

The controller provides paths through the SDN for every data flow, identified by its five-tuple (source IP address, destination IP address, source port, destination port and protocol number). One example of a flow is depicted in FIG. 3 by a broken line from the GGSN/PGW/BNG node via several OF switches, TVASs and the PoI towards a PDN/Internet. The SDN switches which are shown as OF switches in the figure base the forwarding decision mainly on matching the five-tuple information with entries in their flow tables. If no match is found, the packet is forwarded to the controller for analysis. In turn the controller configures a bidirectional path through the SDN. By that traffic steering in the Service Network can be achieved on a per data flow base. The configuration is done in a central entity, named in FIG. 3 as the controller. The controller comprises an input for chain selection to configure the chain or flow in the SDN. There is no need for NAT within the Service Network. The same traffic path is secured per data flow in both directions. Chains of TVASs can be established in a flexible way and the order of services is not fixed. TVAS can be allocated and removed from existing chains; each flow can be individually steered based on the five-tuple of its packet's IP header. However, this solution is not easy to implement because of capacity and scalability issues. Potentially every data flow—identified by the five-tuple of the packet header—needs to get have an own path through the SDN, created in real-time by the controller and provided to the SDN switches. This results in huge tables in the SDN switches, especially because one end-user typically opens a multitude of short living flows per data session. In addition to that, many of the data flows have a short time to live (e.g. the parallel data flows to render an http page) which results in non-manageable table update rate in the SDN.

### SUMMARY

It is an object of the present invention to improve forwarding of IP data packets in a service network. This object is achieved by the independent embodiments. Advantageous embodiments are described in the dependent embodiments.

According to a first aspect, a method of controlling a forwarding of IP data packets through a service network is provided. The service network comprises at least one forwarding node which is configured to forward an IP data packet according to a forwarding rule and at least one controller which is configured to provide forwarding rules to the at least one forwarding node. At least one service-providing server is allocated to the service network. The IP data packet enters the service network through a gateway node and comprises an original source port number. The method comprises the steps of defining, by the controller, a path allocated to a service type through the at least one forwarding node and the at least one service-providing server and allocating an identifier to the service type, identifying the type of service. Further the controller provides path related forwarding rules to the at least one forwarding node based on the identifier and the identifier of the service type and a mapping rule between the identifier and the service type to the gateway node. The gateway node receives the IP data packet and determines to which service type said IP data packet refers to. In a next step the gateway node replaces the original source port number of the IP data packet with a source port number encoding the identifier of the determined service type based on the mapping rule. Then the IP data packet is provided to the at least one forwarding node and then forwarded by the at least one forwarding node on the path.

According to a further aspect of the invention a controller for controlling a forwarding of IP data packets, comprising an original source port, through a service network is provided. The controller is configured to provide forwarding rules to at least one forwarding node in the service network which is configured to forward an IP data packet according to the forwarding rules. At least one service-providing server is allocated to the service network and wherein the IP data packet enters the service network through a gateway node. The controller comprises a processing unit configured to define a path allocated to a service type through the at least one forwarding node and the at least one service-providing server and to allocate an identifier to the service type, identifying the type of service. The controller further comprises a first sending unit, configured to provide path related forwarding rules to the at least one forwarding node based on the identifier and a second sending unit, configured to provide to the gateway node, the identifier of the service type and a mapping rule between the identifier and the service type.

According to a further aspect of the invention a gateway node of a service network is provided. The gateway node comprises a first receiving unit, configured to receive an IP data packet and a second receiving unit, configured to receive an identifier of the service type and a mapping rule between the identifier and the service type. The gateway node further comprises two processing units, wherein the first processing unit is configured to determine which service type said IP data packet refers to and the second processing unit is configured to replace the original source port number in the IP header of the IP data packet with a source port number encoding the identifier of the determined service type based on the mapping rule. Further the gateway node comprises a forwarding unit, configured to forward the IP data packet to at least one forwarding node of the service network.

The present invention also concerns computer programs comprising portions of software codes in order to implement the method as described above when operated by a respective processing unit of a user device and a recipient device. The computer program is stored on a non-transitory computer-readable medium. The computer-readable medium may be a permanent or rewritable memory within the user device or the recipient device or located externally. The respective computer program may also be transferred to the user device or recipient device for example via a cable or a wireless link as a sequence of signals.

Further features and benefits of embodiments of the invention will become apparent from the detailed description below.

### BRIEF DESCRIPTION OF THE DRAWINGS

In the following section, the invention will be described with reference to exemplary embodiments illustrated in the figures, in which:

FIG. 1 is a simplified block diagram of an existing implementation of a Service Network;

FIG. 2 is a simplified block diagram of another existing implementation of a Service Network;

FIG. 3 is a simplified block diagram of an existing implementation of a Software Defined Network (SDN) implemented as a Service Network;

FIG. 4 depicts a first exemplary embodiment of the present invention;

FIG. 5 depicts another exemplary embodiment of the present invention,

FIG. 6 is a simplified block diagram of a controller according to an exemplary embodiment of the present invention;

FIG. 7 is a simplified block diagram of a gateway node according to an exemplary embodiment of the present invention; and

FIG. 8 is a flow chart illustrating the steps of an exemplary embodiment of the method of the present invention.

### DETAILED DESCRIPTION

The present invention will now be described more fully hereinafter with reference to the accompanying drawings, in which preferred embodiments of the invention are shown. In the below, for purposes of explanation and not limitation, specific details are set forth in order to provide a thorough understanding of the present invention. It will be apparent to one skilled in the art that the present invention may be practiced in other embodiments that depart from these specific details. For example, although the exemplary embodiments are described in connection with GSM/UMTS/LTE standard terminology to illustrate the present invention, they are equally applicable to other kinds of mobile communication systems. Also, the invention may be practiced in any network to which mobile users may attach. For example, the present invention is applicable to, besides cellular networks, Local Area Networks (LANs), Wireless LANs (WLANs), or similar wireless networks, but also to wireline networks such as, for example, the intranet of a company or the Internet. Further, the term User Equipment (UE) used herein below may be any kind of mobile communication device like a mobile telephone, a Personal Digital Assistant (PDA), a network card, a laptop or any other mobile communication apparatus which is capable of communicating wirelessly (via an air interface) or wirelined with a network. Although a specific protocol stack is used below to describe the present invention, any other suitable protocol stack may equally be used.

Those skilled in the art will further appreciate that the functions explained herein below may be implemented using hardware circuitry, software means, or a combination thereof. The software means may be in conjunction with a programmed microprocessor or a general purpose computer, using an Application Specific Integrated Circuit (ASIC) and/or Digital Signal Processors (DSPs). It will also be apparent that when the present invention is described as a method, it may also be embodied in a computer processor and a non-transitory memory coupled to the processor, wherein the memory is encoded with one or more programs that perform the method when executed by the processor.

FIG. 4 depicts a first exemplary embodiment of the present invention. A service network 44 is designed as a Software Defined Network (SDN) comprises three switches 44a, 44b, 44c which are named in this figure as “OpenFlow” (OF) switches according to the Openflow standard. These OF switches 44a, 44b, 44c can also be named as forwarding nodes because they are configured to forward data packets according to a forwarding table. The forwarding nodes 44a, 44b, 44c are controlled by a controller 43 which is configured to calculate and to provide the forwarding rules to the forwarding node 44a, 44b, 44c (see dotted lines). It is also possible to have more or less than three forwarding nodes 44a, 44b, 44c in the SDN 44. It may also be possible to have more than one controller 43 responsible for the forwarding nodes 44a, 44b, 44c. This results in a separation of control and data layer.

The path of a data packet through the forwarding nodes 44a, 44b, 44c of the SDN 44 can be named as a flow of a data packet. The controller 43 is responsible for defining such flows for the data packets. Further two transparent-value-added-service (TVAS) servers 45, 46 are allocated as service-providing servers to the service network 44. In another example it is possible to have more or less TVASs allocated to the Service Network 44. Each TVAS 45, 46 can be part of a flow for a data packet. It is possible that more than one TVAS 45, 46 may be part of a flow. In the depicted example of FIG. 4, a flow is shown via the thick left-right-arrows through the OF switches 44a, 44b, 44c and TVAS1 45.

Further a gateway node 42 is depicted in FIG. 4 which is arranged between the service network 44 and a gateway node 41 of an Access network. The gateway node 42 of the Access Network can be any kind of node according to the different standards. It is also possible that the depicted gateway node 42 is part of the GGSN/PGW or BNG node 41. The gateway node 42 can be seen as an entry point or an exit point of the Service Network 44. Not shown in FIG. 4 is the Access Network which can be mobile telecommunication network, a wireless network or any other kind of wire line network which connects a UE (not depicted) to the service network. The Access Network is arranged at the GGSN/PGW or BNG network 41 such that the GGSN/PGW or BNG 41 is the entry or exit point of the Access network. The arrangement of the Access Network can e.g. be derived from FIG. 1. FIG. 4 further shows a PoI 47 to a Packet Data Network (PDN) 48 which can be the Internet or any other kind of network. The UE will communicate via the Access Network and the Service Network 44, including at least one service-providing server (TVAS) 45, 46 with a server in the PDN (not shown in FIG. 4).

The controller 43 is configured to define a path which is allocated to a service type. The path describes a way through the Service Network 44. In FIG. 4, the Service Network 44 comprises as an SDN three OF Switches 44a, 44b, 44c through which a path is defined. The path can also be named as a flow through an SDN 44. The path further comprises a TVAS1 45. As a result the path and its nodes 44a, 44b, 44c, 45 provide the execution of a service type according to a defined Quality of Service. If e.g. a service type is defined as a Video service with high resolution and therefore high bandwidth needs, the path should be as short as possible comprising as few as possible forwarding nodes 44a, 44b, 44c with as few as possible latency. The TVAS1 45 might be a server which provides a video coding or de-coding function for this example. Another example might be the provisioning of web services with low speed demands but with a parental control. The path in this example might comprise more OF switches 44a, 44b, 44c with low latency and a TVAS server 45, 46 which provides a filtering of content.

For each service type, which could be firewalls with different parameters, spam filters or virus protection services with different level of protection, content filtering like parental control, transparent Internet caches, HTTP header enrichment or deep Packet Inspection a path or flow is defined and an identifier is allocated to the service type. This allocation can also be done in the controller 43. Further the controller 43 may be configured to provide the path related forwarding rules to the OF switches 44a, 44b, 44c based on the identifier so that each switch now comprises a forwarding table with the identifier and the forwarding behavior or route description. This is done in the control plane of the SDN 44. The OF switches 44a, 44b, 44c are now configured to check incoming packets and based on the determined identifier of the data packets the data packet is forwarded to the neighboring OF switch 44a, 44b, 44c or any other neighbor (e.g. a TVAS 45, 46 or an exit node). If the controller 43 receives additional information regarding for example the implementation of another service or the change of a QoS for a service type the controller 43 can update the OF switches 44a, 44b, 44c. If one OF switch 44a, 44b, 44c is out of order due to a technical problem the controller 43 has to re-arrange the paths for the affected service types. The definition of the flows or paths is therefore very flexible and can be adapted according to any circumstances in the SDN 44.

The controller 43 may further provide the identifier of the service type and a mapping rule between the identifier and the service type to the gateway node 42 in the control plane. The mapping rule is a definition of the relationship between a service type and the identifier. This can be done by implementing a table in the gateway node 42 comprising the identifier and the related service type in one row of the table. The service type description can e.g. be a complex fingerprint. With this information the gateway node 42 can assign an identifier to a data packet in relation to the service type which should be executed for this data packet.

An IP data packet is received by the gateway node 42 via the Access Network. The gateway node 42 can be a sole node or its function can be integrated into the GGSN of a UMTS network, the PGW of an LTE network or any other node of an Access Network. Referring to FIG. 4, the GGSN/PGW/BDN node 41 and the gateway node 42 can be a combined node. The gateway node 42 determines to which service type said IP data packet refers to. This can e.g. be done by a deep packet inspection (DPI) to analyze the content of the data packet to derive the requested service type. The deep packet inspection can be done by another node in any of the networks and the result can be sent to the gateway node 42. The gateway node 42 can then select the related identifier. It might also be possible that the gateway node 42 executes the DPI itself.

In another exemplary embodiment, the gateway node 42 considers at least one parameter in one of the header fields of the received IP data packet. It is possible to check the source or destination IP address field in the IP header. Further it is possible that the gateway node 42 checks the original source port number or the destination port number to determine the applications for this IP data packet. Other fields are the protocol type field or multiprotocol label switching (MPLS) data to determine the requested service type. It is further possible that the parameter is a service identifier (I-SID) according to IEEE (Institute of Electrical and Electronic Engineers) standard 802.1ah or a service tag (S-TAG) according to IEEE 802.1ad. In another example the parameter can be a VLAN identifier in the Ethernet header according to standard IEEE 802.1Q.

In the data plane the gateway node 42 will replace the original source port number of the IP data packet with a source port number encoding the identifier of the determined service type based on the mapping rule. In one example the identifier consists of 6 bits which leads to 64 different service types. It is therefore necessary to reduce the port number information to the remaining bits and calculate a new source port number. If the original source port number consists of 16 bits the new source port number has a length of 10 bits+6 bits identifier information. Depending on the setup of the IP network it is also possible to just replace the 6 lowest bits of an original source port number with the identifier to build a new source port number. It is also possible to have more or less bits used for the identifier. Further it is possible to calculate a completely new source port number out of the determined identifier and the original source port number by using any mathematical calculation but it must be possible for the forwarding nodes 44a, 44b, 44c to decode the identifier out of the source port number. Therefore the source port number is not randomly chosen from a pool of ports but instead assigned such that it encodes a specific chain of TVASs 45, 46 and forwarding nodes 44a, 44b, 44c (OF switches) to be passed. The new source port number can also be named as a Traffic Steering Source Port (TSSP). As another example it is possible to allocate more than one path or flow to a service type to be able to do load balancing on the SDN.

The gateway node 42 will then provide the IP data packet with the replaced source port number to the at least one forwarding node 44a, 44b, 44c of the Service Network 44. The forwarding node 44a, 44b, 44c will forward the IP data packet to its neighboring node 44a, 44b, 44c based on the identifier decoded from the source port number. In other words, the IP packets traverse the software defined transport network 44. Provided that pre-defined paths per TVAS chain exist, the OpenFlow switches 44a, 44b, 44c can base the forwarding decision mainly on matching the source port number with entries in their flow tables. This will reduce the number of entries in the flow table and accelerate the processing speed in the OF switches 44a, 44b, 44c.

When the IP data packet enters a TVAS 45, 46 (in the example of FIG. 4, TVAS1 45 is part of the flow) the content or payload of the data packet might be changed based on the service type provisioning. As an example a video codec with a compression algorithm might change the whole content or payload of the IP data packet but leaves the header of the IP data packet unchanged. The TVAS 45, 46 might also check the content of the IP header (e.g. source IP address or destination IP address) to execute a service. Therefore it is important to keep the address fields of the IP header unchanged.

FIG. 5 depicts a second exemplary embodiment of the present invention. In this embodiment, a second gateway node (Inverse Traffic Steering NAPT) 59 is arranged at the exit of the Service network 44. This second gateway 59 might be arranged at the PoI 47 between the Service Network 44 and the Internet/PDN 48. If the IP data packet arrives at the second gateway 59 the source port number encoding the identifier of the service type is replaced by the original source port number related to this IP data packet. This embodiment has the advantage that the IP data packet can be analyzed later on at the destination server in the PDN/Internet 48 based on the source port number for executing specific services at the destination server. To synchronize the information regarding the identifier referring to an IP data packet and the original source port number of the IP data packet it is possible that the controller 53 exchanges this information with the gateway node 52 and the second gateway node 59. Therefore the gateway node 52 has to send this information to the controller 53. As depicted in FIG. 5, the controller 53 (Service Chaining Control) provides the five-tuple of the IP data packet and the TSSP as the identifier to both gateways 52, 59. FIG. 5 additionally shows that the controller 53 is split up into a TVAS Chain Selector and a Path Provisioner. The TVAS Chain Selector is responsible for the setup of service chains and the TSSP (identifier). The Path Provisioner provides path information to the OF switches. It is also possible that the TVAS Chain Selector is not integrated into the controller 53 but is a sole node in the network. Further FIG. 5 shows an Input for chain selection which could be an interface for an operator to setup a new configuration or a new service type. Provided that pre-defined paths per TVAS chain exist, the OpenFlow switches can base the forwarding decision mainly on matching the source port number with entries in their flow tables. In the embodiment illustrated in FIG. 5, TSSPs with their four last significant bits=0001 would correspond to a TVAS chain that only includes TVAS-1 45. If the source port would be replaced by a TSSP with their four last significant bits=0002, the traffic would be directed to TVAS-1 and then TVAS-2 46. Before the end-user traffic leaves the Service Network 44 towards the PoI 47, the TSSP is replaced by the original source port in the inverse gateway node 52 or second gateway node 59. By that, the IP packets leaving the Service Network 44 towards the PoI 47 have their original source port in their IP header. This allows the selection of different service chains during a data flow, i.e. a TVAS 45, 46 can be linked in or out without changing the end-users source port presented to the PoI/Internet. The control layer of this solution called Service Chaining Control consists of two logical entities: The TVAS Chain Selector and the Path Provisioner as depicted in FIG. 5. The TVAS Chain Selector selects an appropriate TVAS chain. It sends the relation between the five-tuple of an expected data flow and the TSSP to the second gateway node 59. The input for the chain selector can be multifold, e.g. it may be information from a DPI node or a 3GPP PCRF.

Whenever a new TVAS chain needs to be set up, the Path Provisioner configures the requested bidirectional paths within the OpenFlow network and the TVAS Chain Selector is updated to consider this new chain. New TVAS chains may be setup due to new business cases from the network operator, due to introduction of new TVAS, or due to instantiation of new instances of a particular TVAS for load balancing reasons. It shall be mentioned that load-balancing could also be achieved by different means not requiring the setup of new TVAS chains as seen by the TVAS Chain Selector function.

In another exemplary embodiment, the gateway node 52 sends the information (identifier and original source port number) to the second gateway node 59. After the IP data packet left the second gateway node 59 this information can be kept in the second gateway node 59 for the IP data packets in download direction (from the PDN/Internet 48 to the UE).

As an advantage, the paths are pre-provisioned for every service type. This reduces the amount of forwarding rules in each forwarding nodes of the Service Network. The forwarding rules are very short and easy to handle because they are only related to an identifier of the IP data packet. It is additionally very easy to change the setup of chains or paths in this Service Network 44 if new service-providing servers have to be inserted in any chain or path. Relevant information for the destination server of an IP data packet remains unchanged.

The implementation of a second gateway node 59 has the further advantage that it is possible to change the path during a communication session in which several IP data packets related to this communication are transferred through the Service Network 44. If the path through the service network changes due to (e.g.) congestion or a change in the required TVAS-setup to be applied to the IP data packets, which means different service types are selected implying different encoded service type identifier in the source port number, the second gateway node 59 hide any change on the source port number for a given flow of IP data packets by reassigning the original source port number at the exit of the service network. Depending on the setup of the service network 44 and the use case, the second gateway node 59, which can also be named as an inverse gateway node 59, may not be needed. If a change of service chains is not required during a data flow, this solution will work also without the inverse gateway node 59.

However, if the service chain or path changes for ongoing data flows are envisaged, extra care must be taken of the usage of mapping rules modifications in the Traffic Steering and inverse Traffic Steering. For some (transition) period of times, more than one rule will apply to the same end-to-end IP flows. For uplink traffic (traffic from the Access Network to the PDN/Internet) of a specific flow the mapping function must map traffic according to the new chain. The inverse mapping function must map traffic from both the TSSP of the old chain and the TSSP of the new chain to exactly the same original source port. For downlink traffic of the same flow the inverse mapping function must map traffic according to the new chain. The mapping function in the gateway node 52 must map traffic from both the TSSP of the old and the new chain to exactly the same original source port.

In another exemplary embodiment, the gateway node 52 and the second gateway node 59 may be combined in one physical entity. This will reduce the synchronization overhead.

In another exemplary embodiment, it is necessary that the TVAS requires original source port information. Some services such as TCP proxies may require the original source port information to map data flows internally. In this case, the TVAS 45, 46 can be “shielded” by a pair of inverse or second gateway nodes 59 and gateway nodes 52. Before the data flow enters the TVAS in uplink direction, the source port number is replaced by the original source port number. When the IP packets leave the TVAS towards the next TAVS or PoI, the original source port number is again replaced by the source port number encoding the identifier of the determined service type.

Gateway node 52 and second/inverse gateway node 59 can be implemented in multiple instances: The sufficient precondition to ensure all flows of the same data flow traverse the same instance and that each gateway node needs to be synchronized with a single inverse gateway node, is to enforce that traffic with the same source IP address entering the Service Network is always processed by the same instance. This can be achieved using existing routing technologies (e.g. policy based routing on source address).

FIG. 6 is a simplified block diagram of a controller according to an exemplary embodiment of the invention. The controller comprises a processing unit which is configured to define a path allocated to a service type through the at least one forwarding node and the at least one service-providing server and to allocate an identifier to the service type, identifying the type of service. Not shown in FIG. 6 is a possible input/output unit or an O&M device which allows defining service types by the operator of the Service Network. The Processing unit can consist of two logical instances: The TVAS Chain Selector and the Path Provisioner.

The TVAS Chain Selector selects an appropriate TVAS chain, which might consists of at least one TVAS server, relating to a service type. It sends the relation between the five-tuple of an expected data flow and the TSSP/identifier to the gateway node via the second sending unit. The second sending unit is configured to provide to the gateway node the mapping rule between the identifier and the service type. Whenever a new TVAS chain needs to be set up, the Path Provisioner configures the requested bidirectional paths within the Service Network and the TVAS Chain Selector is updated to consider this new chain. New TVAS chains may be setup due to new business cases from the network operator, due to introduction of new TVAS, or due to instantiation of new instances of a particular TVAS for load balancing reasons. It shall be mentioned that load-balancing could also be achieved by different means not requiring the setup of new TVAS chains as seen by the TVAS Chain Selector function. The Controller further calculates the path related to a new service type and provides, via a first sending unit, path related forwarding rules to the at least one forwarding node based on the identifier.

According to FIG. 6 the controller may also include a third sending unit which is configured to provide to a second gateway node, the original source port number and the identifier of the IP data packet, comprising the replaced source port number, received from the gateway node to synchronize the information in the gateway nodes. This third sending unit is an optional feature and not necessary if only one gateway node is used in a scenario like it is depicted in FIG. 4. It is possible that at least two sending units are combined into one sending unit or all sending units are combined in one sending unit.

An option to gain capacity using internal instead of external interfaces is to collocate the chain selector and the gateway/inverse gateway in one physical entity. It shall be noted that a “chain selector” function can also be easily replicated into different instances without inter instance synchronization requirements.

FIG. 7 is a simplified block diagram of a gateway node according to an exemplary embodiment of the present invention. The gateway node comprises a first receiving unit, configured to receive an IP data packet. The gateway node comprises a second receiving unit which is configured to receive an identifier of the service type and a mapping rule between the identifier and the service type Further the gateway node comprises a first processing unit configured to determine which service type said IP data packet refers to. It is possible that the first processing unit comprises a further receiving entity to receive an indicator from a DPI—node which is performing DPI on the same IP data packet before it enters the gateway node. In another embodiment the first processing unit is configured to determine to which service type said IP packet refers to by considering a parameter in at least one of the header fields of the IP data packet. The parameter of the at least one header field of the IP data packet can be at least the source or destination IP address, the original source or destination port number, a protocol type or Multiprotocol label switching, MPLS, data. It is further possible that the parameter is an IEEE 802.1ah with service identifier (I-SID), IEEE 802.1ad with service tag (S-TAG) or IEEE 802.1Q tag with VLAN identifier.

FIG. 8 is a flow chart illustrating the steps of an exemplary embodiment of the method of the present invention. In step 81, the controller defines a path allocated to a service type through the at least one forwarding node of a Service Network and the at least one service-providing server allocated to the service network. In step 82, the controller allocates, an identifier to the service type, identifying the type of service. In step 83, the controller provides path related forwarding rules to the at least one forwarding node based on the identifier. In step 84, the controller provides to the gateway node, the identifier of the service type and a mapping rule between the identifier and the service type. In step 85, the gateway node receives the IP data packet and determines to which service type said IP data packet refers to. In step 86, the gateway node replaces the original source port number of the IP data packet with a source port number encoding the identifier of the determined service type based on the mapping rule. In step 87, the IP data packet is provided by the gateway node to the at least one forwarding node and the IP data packet is then forwarded by the at least one forwarding node on the path.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A method of controlling forwarding of IP data packets through a service network, wherein the service network comprises at least one forwarding node, which is configured to forward an IP data packet according to a forwarding rule, and at least one controller, which is configured to provide forwarding rules to the at least one forwarding node, wherein at least one service-providing server is allocated to the service network, wherein the IP data packet enters the service network through a gateway node and includes an original source port number, the method comprising the steps of:
defining by the controller, a path allocated to a service type through the at least one forwarding node and the at least one service-providing server;
allocating by the controller, an identifier to the service type, identifying the type of service;
providing by the controller, path related forwarding rules to the at least one forwarding node based on the identifier;
providing by the controller to the gateway node, the identifier of the service type and a mapping rule between the identifier and the service type;
receiving by the gateway node, the IP data packet and determining which service type said IP data packet refers to;
replacing by the gateway node, the original source port number of the IP data packet with a source port number encoding the identifier of the determined service type based on the mapping rule;
providing the IP data packet to the at least one forwarding node; and
forwarding the IP data packet on the path by the at least one forwarding node.

2. The method according to claim 1, wherein the identifier is encoded in a section of the source port number.

3. The method according to claim 1, wherein the source IP address is maintained unchanged.

4. The method according to claim 1, wherein the at least one service-providing server is configured to change the content of the IP data packet while maintaining the IP header.

5. The method according to claim 1, wherein the gateway node determines which service type the IP data packet refers to by considering the results of an inspection of the payload of the received IP data packet.

6. The method according to claim 1, wherein the gateway node determines which service type the IP packet refers to by considering a parameter in at least one of the header fields of the IP data packet.

7. The method according to claim 6, wherein the parameter of the at least one header field of the IP data packet is at least one of the following:
source IP address;
destination IP address;
original source port number;
destination port number;
protocol type;
Multiprotocol label switching (MPLS) data; and
IEEE 802.1Q tag with VLAN identifier.

8. The method according to claim 1, wherein the IP data packet leaves the service network through a second gateway node, and wherein the method further comprises the steps of:
receiving by the second gateway node, the IP data packet; and
replacing the source port number of the IP data packet with the original source port number of the IP data packet.

9. The method according to claim 8, wherein the controller synchronizes the gateway node and the second gateway node by exchanging the original source port number and the identifier of the IP data packet, including the replaced source port number, between the gateway node and the second gateway node.

10. A controller for controlling forwarding of IP data packets that include an original source port number, through a service network, wherein the controller is configured to provide forwarding rules to at least one forwarding node in the service network that forwards an IP data packet according to the forwarding rules, wherein at least one service-providing server is allocated to the service network and wherein the IP data packet enters the service network through a gateway node, the controller comprising:
a processing unit configured to define a path allocated to a service type through the at least one forwarding node and the at least one service-providing server, and to allocate to the service type, an identifier identifying the type of service;
a first sending unit configured to provide path-related forwarding rules to the at least one forwarding node based on the identifier; and
a second sending unit configured to provide to the gateway node, the identifier of the service type and a mapping rule between the identifier and the service type.

11. The controller according to claim 10, further comprising a third sending unit configured to provide to a second gateway node, the original source port number and the identifier of the IP data packet, including the replaced source port number.

12. A gateway node of a service network, comprising:
a first receiving unit configured to receive an IP data packet;
a second receiving unit configured to receive an identifier of a service type and a mapping rule between the identifier and the service type;
a first processing unit configured to determine which service type said IP data packet refers to;
a second processing unit configured to replace the original source port number of the IP data packet with a source port number encoding the identifier of the determined service type based on the mapping rule; and
a forwarding unit configured to forward the IP data packet to at least one forwarding node of the service network.

13. The gateway node according to claim 12, wherein the gateway node comprises a sending unit configured to send to a second gateway node, the original source port number and the identifier of the IP data packet, including the replaced source port number.

14. The gateway node according to claim 12, wherein the first processing unit is configured to determine to which service type said IP data packet refers by considering the results of an inspection of the payload of the received IP data packet.

15. The gateway node according to claim 12, wherein the first processing unit is configured to determine which service type said IP packet refers to by considering a parameter in at least one of the header fields of the IP data packet.

16. The gateway node according to claim 15, wherein the parameter of the at least one header field of the IP data packet is at least one of the following:
source IP address;
destination IP address;
original source port number;
destination port number;
protocol type;
Multiprotocol label switching (MPLS) data; and
IEEE 802.1Q tag with VLAN identifier.

17. A system for forwarding IP data packets through a service network, wherein the service network comprises at least one forwarding node, which is configured to forward an IP data packet according to a forwarding rule, wherein at least one service-providing server is allocated to the service network and wherein the IP data packet enters the service network through a gateway node, the system comprising:
at least one controller configured to provide forwarding rules to the at least one forwarding node, the controller comprising:
a processing unit configured to define a path allocated to a service type through the at least one forwarding node and the at least one service-providing server, and to allocate to the service type, an identifier identifying the type of service;
a first sending unit configured to provide path-related forwarding rules to the at least one forwarding node based on the identifier; and
a second sending unit configured to provide to the gateway node, the identifier of the service type and a mapping rule between the identifier and the service type;
wherein the gateway node comprises:
a first receiving unit configured to receive the IP data packet;
a second receiving unit configured to receive the identifier of the service type and the mapping rule between the identifier and the service type;
a first processing unit configured to determine which service type said IP data packet refers to;
a second processing unit configured to replace the original source port number of the IP data packet with a source port number encoding the identifier of the determined service type based on the mapping rule; and
a forwarding unit configured to forward the IP data packet to at least one forwarding node of the service network.

18. A computer program product comprising program code embedded on a non-transitory memory, the program code to be executed by at least one processor of a controller for controlling forwarding of IP data packets through a service network, wherein the service network comprises at least one forwarding node configured to forward an IP data packet according to a forwarding rule, and the controller, which is configured to provide forwarding rules to the at least one forwarding node, wherein at least one service-providing server is allocated to the service network, wherein the IP data packet enters the service network through a gateway node and includes an original source port number, wherein execution of the program code causes the controller to perform the following steps:
defining a path allocated to a service type through the at least one forwarding node and the at least one service-providing server;
allocating an identifier to the service type, identifying the type of service;
providing path related forwarding rules to the at least one forwarding node based on the identifier; and
providing to the gateway node, the identifier of the service type and a mapping rule between the identifier and the service type;
wherein the gateway node is configured to:
receive the IP data packet and determine which service type the IP data packet refers to;
replace the original source port number of the IP data packet with a source port number encoding the identifier of the determined service type based on the mapping rule; and
provide the IP data packet to the at least one forwarding node for forwarding the IP data packet on the path.
